(19) United States
(12) Patent Application Publication
(10) Pub. No.: US 2004/0101660 A1
(43) Pub. Date: May 27, 2004

(54) Image protective film, recorded matter using the same, and method for producing recorded matter using the image protective film

(75) Inventors: Teruaki Kaieda, Nagano (JP); Hiroyuki Onishi, Nagano (JP); Masahiro Hanmura, Nagano (JP); Koichi Terao, Nagano (JP); Etsuo Okaue, Nagano (JP)

Correspondence Address: Ladas & Parry, 26 West 61 Street, New York, NY, 10023, US

(73) Assignee: SEIKO EPSON CORPORATION

(21) Appl. No.: 10/392,376

(22) Filed: Mar. 19, 2003

(30) Foreign Application Priority Data
Mar. 20, 2002 (JP) P.2002-079766
Aug. 23, 2002 (JP) P.2002-243485
Dec. 20, 2002 (JP) P.2002-370058
Mar. 18, 2003 (JP) P.2003-073598

(51) Int. Cl. B32B 3/00

(52) U.S. Cl. 428/195.1

(57) ABSTRACT

The invention provides an image protective film used for lamination on a recoding surface of a recording medium by a heat transfer type overcoat system after the formation of an image on the recording surface, which comprises a support having laminated thereon a first protective layer and a second protective layer in this order, each of which is formed of a thermoplastic resin.

### FIELD OF THE INVENTION

The present invention relates to an image protective film comprising a support having provided thereon a thermoplastic resin layer for protecting an image formed on a recording surface of a recording medium by a digital system, particularly by an ink jet system, and further relates to recorded matter using the same, and a method for producing recorded matter using the image protective film.

### BACKGROUND OF THE INVENTION

An ink jet system is a printing system in which droplets of ink are ejected through minute nozzles of a recording head to allow the droplets to adhere to a recording surface of a recording medium such as paper, thereby making a print. Heat transfer type overcoat system treatment has hitherto been known in which using an image protective film comprising a support having laminated thereon a thermoplastic resin layer, the resin layer is heat pressed on the recording surface of the recording medium on which an image has been formed by the ink jet system, and the support is thereafter separated from the resin layer to provide a protective layer comprising the resin layer, in order to improve image fastness (for example, refer to JP-A-2000-233474 (the term “JP-A” as used herein means an “unexamined published Japanese patent application”)).

In general, in the transfer formation of the protective layer by overcoat system treatment (which includes a system in which an image protective film with an adhesive layer is used to eliminate the necessity of a separation step, as well as the above-mentioned heat transfer type involving the separation step of the support) including the above-mentioned heat transfer type treatment, a step of thermally transferring the thermoplastic resin layer from the support onto the recording medium by use of a heat pressing means is generally used. However, taking into account damage of a printed image-receiving layer by heat and deterioration of a recorded image caused thereby, the temperature and time of heating applicable with the heat pressing means are forced to be limited. According to the conventional methods, therefore, adhesion of the thermoplastic resin layer (protective layer) to the recording medium has been insufficient in some cases.

With recent increased print speed by the ink jet system, an ink jet recording medium has come to be required to have high-speed ink absorption, and the composition ratio of porous inorganic particles such as amorphous silica contained in an image-receiving layer thereof to a binder tends to increase. A surface of such an image-receiving layer is roughened to cause poor smoothness, so that adhesion of the thermoplastic resin layer to the surface tends to be significantly deteriorated. The reason for this is that the thermoplastic resin layer becomes difficult to fully enter concave portions by melting.

As described above, in the heat transfer type overcoat system using the conventional image protective film, heat transfer is forced to be carried out under such mild heating conditions that the recorded image is not deteriorated by heat. Accordingly, adhesion of the thermoplastic resin layer to the recording medium, particularly to the ink jet recording medium having the ink-receiving layer containing the porous inorganic particles is poor, so that there have been the problem that the resin layer partly comes up from the recording surface, or peeled off together with the support in the extreme case (a reduction in releasability of the support), in the course of separating the support. When the image is formed using a pigment ink, the coming up of the resin layer from the recording surface particularly causes trouble. That is to say, when the pigment ink is ejected to the recording surface, most of the coloring agent (pigment) adheres onto the recording surface without penetrating into the recording medium. The above-mentioned coming up of the resin layer lowers image density, or causes the coloring agent to be transferred to the side of the resin layer that has come up from the recording surface, resulting in occurrence of blurring or peeling off of the image.

As a means for achieving excellent adhesion under such relatively mild heating conditions that the recorded image is not deteriorated by heat, a method of lowering the glass transition temperature (Tg) of the resin constituting the thermoplastic resin layer in the image protective film is conceivable. However, when the Tg of the thermoplastic resin layer transferred onto the recording medium to form the protective layer is lowered to such an extent that the above-mentioned object can be attained, the problem is encountered that scratch resistance of the thermoplastic resin layer is deteriorated to become easily harmed. Further, the use of the thermoplastic resin layer low in Tg also raises the problem that a surface of the protective layer becomes sticky at ordinary temperature to deteriorate blocking resistance.

### SUMMARY OF THE INVENITON

It is therefore an object of the invention to provide an image protective film that can adhere a thermoplastic resin layer onto a recording surface of a recording medium on which an image has been formed, under such relatively mild heating conditions that the recorded image is not deteriorated by heat, can smoothly separate only a support without coming up or peeling off of the resin layer from the recording surface, in a subsequent separation step of the support, and can provide high quality recorded matter excellent in gloss, scratch resistance and blocking resistance.

Another object of the invention is to provide recorded matter using the above-mentioned image protective film.

A still other object of the invention is to provide a method for producing the recorded matter using the above-mentioned image protective film.

Other objects and effects of the invention will become apparent from the following description.

The above-mentioned objects of the invention have been achieved by providing an image protective film used for lamination on a recoding surface of a recording medium by a heat transfer type overcoat system after the formation of an image on the recording surface, which comprises a support having laminated thereon a first protective layer and a second protective layer in this order, each of which is formed of a thermoplastic resin.

Further, in the image protective film of the invention, it is preferred that the thermoplastic resin forming the first protective layer has a higher glass transition temperature than the thermoplastic resin forming the second protective layer.

In the image protective film of the invention, the difference in glass transition temperature between the thermoplastic resin forming the first protective layer and the thermoplastic resin forming the second protective layer is preferably from 10° C. to 100° C.

In the image protective film of the invention, the glass transition temperature of the thermoplastic resin forming the first protective layer is preferably from 30° C. to 130° C.

In the image protective film of the invention, it is preferred that the first protective layer contains inorganic particles.

In the image protective film of the invention, the content of the inorganic particles is preferably from 10% to 60% by weight based on the resin solid content.

In the image protective film of the invention, the inorganic particles are preferably colloidal silica.

In the image protective film of the invention, the complex elastic modulus of the thermoplastic resin forming the second protective layer at 40° C. in a temperature dispersion curve of dynamic viscoelasticity measured at a frequency of 1 Hz, a rate of temperature increase of 2° C./minute and a minimum tension of 10 mN is preferably 4.0×10⁸ Pa or more.

In the image protective film of the invention, the complex elastic modulus of the thermoplastic resin forming the second protective layer at 100° C. in a temperature dispersion curve of dynamic viscoelasticity measured at a frequency of 1 Hz, a rate of temperature increase of 2° C./minute and a minimum tension of 10 mN is preferably 2.5×10⁵ Pa or less.

In the image protective film of the invention, the glass transition temperature of the thermoplastic resin forming the second protective layer is preferably from −20° C. to 60° C.

In the image protective film of the invention, it is preferred that the first protective layer contains wax.

Further, a method for producing recorded matter of the invention is a method for producing recorded matter using the above-mentioned image protective film, and comprises the steps of forming an image on a recording surface of a recording medium, and laminating the image protective film on the image-recorded recording medium so that the recording surface and the second protective layer overlap, followed by heat pressing, wherein the heating temperature in the heat pressing is equal to or higher than the glass transition temperature of the thermoplastic resin forming the second protective layer.

In the method for producing the recorded matter of the invention, the above-mentioned image is preferably formed by an ink jet system.

The recorded matter of the invention is recorded matter produced by the above-mentioned method for producing the recorded matter.

### BRIEF DESCRIPTION OF THE DRAWINGS

FIG. 1 is a schematic cross sectional view illustrating one embodiment of an image protective film of the invention; and

FIG. 2 is a schematic side view showing one embodiment of a production apparatus used for carrying out a production method of the invention.

### DETAILED DESCRIPTION OF THE INVENTION

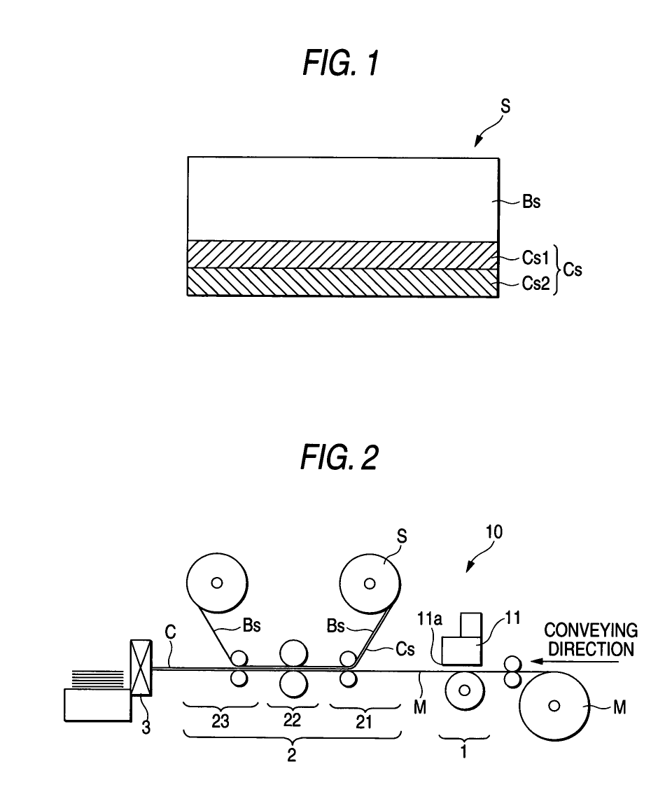

First, the image protective film of the invention (hereinafter also briefly referred to as the “protective film”) will be described below based on a preferred embodiment thereof with reference to FIG. 1.

FIG. 1 is a schematic cross sectional view illustrating an image protective film S of this embodiment. This image protective film S has a support Bs and a thermoplastic resin layer Cs, and the thermoplastic resin layer Cs comprises a first protective layer Cs1 and a second protective layer Cs2 laminated on the support Bs in this order. The first protective layer Cs1 and the second protective layer Cs2 are heat transferred from the support Bs onto a recording surface of a recording medium while maintaining their laminated state to form a protective layer covering the recording surface. The first protective layer Cs1 forms an uppermost layer of the protective layer. On the other hand, the support Bs is separated from the first protective layer Cs1 in the course of heat transfer, and recovered.

As the support Bs, there is used a support having such heat resistance and mechanical strength that its form can be stably maintained under specified heat pressing conditions in overcoating and good releasability from the thermoplastic resin layer heat pressed on the recording surface. As such a support, there can be used, for example, a sheet or a film formed of a material such as polyethylene terephthalate (PET), biaxially oriented polypropylene (OPP), polyethylene naphthalate (PEN), polyphenyl sulfide (PPS), polyethersulfone (PES), polystyrene (PS) or polypropylene (PP).

There is no particular limitation on the thickness of the support Bs as long as it is set so that the above-mentioned functions are obtained. However, taking into account thermal conductivity, adhesion, handling properties and the prevention of the inclusion of bubbles in overcoating, it is preferably from 8 to 60 μm, and more preferably from 10 to 50 μm.

In order to more enhance heat resistance, the support Bs may contain fine ceramic particles, or a surface thereof may be coated with a heat-resistant resin such as a polyester resin, a polyacrylic ester resin, a polyvinyl acetate resin, a polyurethane resin, a styrene-acrylate resin, a polyacrylate resin, a polyacrylamide resin, a polyamide resin, a polyether resin, a polystyrene resin, a polyolefin resin such as a polyethylene resin or a polypropylene resin, a vinyl resin such as a polyvinyl chloride resin or a polyvinyl alcohol resin, a cellulose-based resin such as a cellulose resin, a hydroxyethyl cellulose resin or a cellulose acetate resin, a polyvinyl acetal resin such as a polyvinyl acetoacetal resin or a polyvinyl butyral resin, or a heat-resistant resin such as a silicone-modified resin or a long-chain alkyl-modified resin, as needed.

Further, in order to improve releasability of the support, to prevent adhesion of dust caused by static electricity, to improve blocking resistance and to improve design of a surface of the protective layer (thermoplastic resin layer), various surface treatment processes such as separation (release) treatment, antistatic treatment, corona discharge treatment and emboss treatment can also be applied to a protective layer-forming surface of the support Bs and/or the opposite surface thereof. The release treatment is treatment in which a surface to be treated is coated with a silicone resin, a fluororesin, a melamine resin or colloidal silica as a release agent. When this treatment is applied to the protective layer-forming surface, it is effective for improvement in releasability (transferring ability) of the support. On the other hand, when this treatment is applied to the opposite surface of the protective layer-forming surface, it is effective for the prevention of heat fusing to a heat pressure apparatus such as a heat roll, improvement in blocking resistance and improvement in slipperiness in paper feeding. The thickness of the support is usually from 0.5 to 5 μm. The corona discharge treatment is treatment of passing the support (film) through a space in which corona discharge is generated (for example, between a pair of electrodes facing each other) to improve wetting tension of its surface. When this treatment is applied to the protective layer, the adhesion between the support and the protective layer can be enhanced.

Preferred specific examples of the supports Bs include an OPP film whose protective layer-forming surface is subjected to the corona discharge treatment, and a PET film whose opposite surface of the protective layer-forming surface (surface on which no protective layer is formed) is subjected to the release treatment. The OPP film is excellent in blocking resistance. On the other hand, when it is used as the support without modification, it is poor in adhesion with the protective layer, which causes the possibility of the inconvenience occurring that the protective layer is separated from the support before the heat transfer treatment. However, application of the corona discharge treatment to the protective layer-forming surface can remove such a defect of the OPP film to be able to obtain the protective film making use of the features of the OPP film. Contrary to the OPP film, the PET film has the problem of poor block resistance, so that the PET film is preferred in which the release treatment is applied as described above to the surface on which no protective layer is formed.

The thermoplastic resin layer Cs comprises the first protective layer Cs1 and the second protective layer Cs2 that are separate thermoplastic resin layers different in composition. As the constitution of the thermoplastic resin layer Cs, there are two embodiments of a first embodiment and a second embodiment, which can be appropriately selected.

First Embodiment

The first embodiment is an embodiment in which the thermoplastic resin forming the first protective layer Cs1 is higher in glass transition temperature (TG) than the thermoplastic resin forming the second protective layer Cs2. As described above, the thermoplastic resin layer is formed so as to have a two-layer structure, and the Tg of the thermoplastic resin forming the second protective layer pressed on the recording surface is made lower than that of the thermoplastic resin forming the first protective layer, whereby the second protective layer makes it possible to secure good adhesion to the recording surface (good releasability of the support), and the first protective layer makes it possible to form the protective layer excellent in scratch resistance and blocking resistance, and difficult to be harmed.

The above-mentioned term “the Tg of the thermoplastic resin forming the first protective layer or the second protective layer” means the weight average Tg. That is to say, for example, when the first protective layer contains two kinds of thermoplastic resins having a Tg of 77° C. and a Tg of 50° C. at a weight ratio of 3:2, the weight average Tg of the thermoplastic resin forming the first protective layer is [(77×3+50×2)/(3+2)=] 66.2° C., which is “the Tg of the thermoplastic resin forming the first protective layer”. In this case, the Tg (weight average Tg) of the thermoplastic resin forming the second protective layer is less than 66.2° C.

The difference in Tg between the thermoplastic resin forming the first protective layer Cs1 and the thermoplastic resin forming the second protective layer Cs2 is preferably from 10° C. to 100° C., and more preferably from 20° C. to 90° C.

Further, the Tg itself of the thermoplastic resin forming the first protective layer Cs1 is preferably from 30° C. to 130° C., and more preferably from 35° C. to 125° C., from the viewpoint of the balance between scratch resistance and blocking resistance.

On the other hand, the Tg itself of the thermoplastic resin forming the second protective layer Cs2 is preferably from −20° C. to 60° C., and more preferably from −15° C. to 55° C., from the viewpoints of adhesion and film forming properties.

Second Embodiment

The second embodiment is an embodiment in which the first protective layer Cs1 contains inorganic particles. In this second embodiment, the first protective layer Cs1 constituting an uppermost layer of the protective layer contains the inorganic particles, thereby intending to improve blocking resistance and scratch resistance. The same effect as with the thermoplastic resin in the first embodiment is obtained. In respect to improvement in blocking resistance, it is unnecessary to particularly add the inorganic particles to the second protective layer Cs2. However, it is possible to add the inorganic particles to the second protective layer Cs2 as needed. In that case, the content of the inorganic particles in the second protective layer Cs2 is preferably smaller than the content of the inorganic particles in the first protective layer Cs1.

As the above-mentioned inorganic particles, preferred is colloidal silica. The content of the above-mentioned inorganic particles in the first protective layer Cs1 is preferably from 10% to 60% by weight based on the resin solid content. When the content of the inorganic particles is outside this range, there is the possibility of film forming properties, blocking resistance and color development failing to be balanced.

In the second embodiment, there is no such a limitation that is imposed on the first embodiment concerning the thermoplastic resins forming the first protective layer Cs1 and the second protective layer Cs2, and the Tg of the thermoplastic resin may be the same between the first protective layer Cs1 and the second protective layer Cs2. From the viewpoints of securing good adhesion to the recording surface and good releasability of the support, the Tg of the thermoplastic resin forming the second protective layer Cs2 is preferably −20 to 60° C., more preferably −15 to 55° C.

The protective film S comprising the thermoplastic resin layer Cs constituted as described above is usually stored as many cut sheets in the stacked state, or as a roll formed by rolling up the long film. In either storage form, there is fear of blocking between the second protective layers Cs2, or between the second protective layer Cs2 and the support Bs. Consequently, from the viewpoint of the prevention of such blocking in storing the film, the complex elastic modulus of the thermoplastic resin forming the second protective layer Cs2, the modulus being obtained by the dynamic viscoelasticity measurement at 40° C., is preferably 4.0×10⁸ Pa or more, and more preferably 5.5×10⁸ Pa or more. The use of the thermoplastic resin having a complex elastic modulus within such a range makes it unnecessary to conduct conventional special treatment for preventing the above-mentioned blocking, for example, the release treatment on a surface of the support Bs, which causes an increase in productivity of the protective film.

Further, when bubbles are included between the protective layer and the recording layer, the appearance becomes undesirable, and the presence of the bubbles on an image results in a decrease in image density. Consequently, from the viewpoint of the prevention of such inclusion of the bubbles, the complex elastic modulus of the thermoplastic resin forming the second protective layer Cs2, the modulus being obtained by the dynamic viscoelasticity measurement at 100° C., is preferably 2.5×10⁵ Pa or less, and more preferably 2.0×10⁵ Pa or less.

As the thermoplastic resin forming the second protective layer Cs2, there is used one satisfying the ranges of the above-mentioned two complex elastic moduli ranges (at 40° C. and 100° C.) at the same time, thereby being able to enhance blocking resistance in storing the film and ability for preventing bubbles from being included at the same time.

The complex elastic moduli as used in the invention are determined as complex elastic moduli at 40° C. and 100° C. in a temperature dispersion curve of dynamic viscoelasticity prepared from the measurement of a viscoelastic spectrometer at a temperature of 21±2° C. and a humidity of 60%±5%, under an atmosphere of nitrogen gas, at a frequency of 1 Hz, a rate of temperature increase of 2° C./minute and a minimum tension of 10 mN.

In the first and second embodiments, the thermoplastic resins forming the first protective layer Cs1 and the second protective layer Cs2 include polyvinyl acetal, an acrylic resin, an acrylic-styrene resin, an acrylic-urethane resin, a vinyl chloride-vinyl acetate resin and a styrenic resin. Using one of these resins or a mixture of two or more of them, characteristic values such as the Tg and the complex elastic modulus are adjusted so as to fall within the above-mentioned ranges.

There is no particular limitation on the form of the above-mentioned thermoplastic resin. The thermoplastic resin may be in the solid form such as the pellet form, or in the emulsion form. The emulsion is an aqueous emulsion in which particles of the thermoplastic resin are dispersed in an aqueous solution containing water as a main ingredient, and the use of the thermoplastic resin particles having an average particle size of about 50 μm to about 300 μm is preferred in respect to film forming properties.

In particular, of the aqueous resin emulsions, the core-shell type resin emulsion in which the thermoplastic resin particles having a core-shell structure are used as a dispersoid is excellent in film forming properties, so that it is effective as the material forming the first protective layer Cs1 and the second protective layer Cs2, particularly as the material forming the first protective layer Cs1 constituting the uppermost layer of the protective layer. The core-shell structure is a structure that two or more different resins exist in a phase-separated state, and generally comprises a core portion and a shell portion surrounding the core portion. The core-shell structure includes a form in which the core portion is completely covered with the shell portion, a form in which the core portion is partially covered with the shell portion, a form in which a part of the resin forming the shell portion forms a domain in the core portion, and a multilayer form of three or more layers in which one or more resin layers different from the core portion and the shell portion in composition are interposed between them. Any of these forms can be suitably used in the invention.

In the thermoplastic resin particles having the core-shell structure, it is preferred that the weight average Tg of the thermoplastic resin constituting the core portion is higher than that of the thermoplastic resin constituting the shell portion, and it is more preferred that the difference in weight average Tg between both resins is 30° C. or more. Film forming properties can be compatible with blocking resistance by making the weight average Tg of the thermoplastic resin constituting the core portion higher than that of the thermoplastic resin constituting the shell portion as described above.

The core-shell type resin emulsion can be produced by know seed emulsion polymerization. As the resins constituting the core portion and the shell portion, there are preferably used the above-mentioned thermoplastic resins. The Tg of the core portion and the shell portion can be adjusted by appropriately controlling the kind of monomer.

Further, a film forming auxiliary can also be added to the above-mentioned aqueous resin emulsion, thereby being able to enhance film-forming properties to form the fine, crack-free protective layer. In particular, as the aqueous resin emulsion for the first protective layer Cs1 constituting the uppermost layer of the protective layer, there is preferably used the emulsion containing the film forming auxiliary. Any film forming auxiliary may be used as long as it can control the minimum film forming temperature of the aqueous resin emulsion. Examples thereof include butyl cellosolve, butyl carbitol, butyl cellosolve acetate, butyl carbitol acetate, diethylene glycol, hexanol and 2-ethylhexanol. They can be used either alone or as a mixture of two or more of them. The content of the film forming auxiliary is preferably from 1% to 20% by weight, and more preferably from 3% to 15% by weight, based on the resin solid content.

Further, in order to more improve scratch resistance and blocking resistance, a wax is preferably added to the first protective layer Cs1. The waxes include, for example, paraffin wax (hydrocarbons having 20 to 40 carbon atoms), microcrystalline wax (hydrocarbons having 30 to 60 carbon atoms), carnauba wax (esters of fatty acids having 24 to 32 carbon atoms and alcohols), candelilla wax (fatty acids having 30 to 32 carbon atoms, alcohols and esters thereof), rice wax (esters of fatty acids having 16 to 32 carbon atoms and alcohols), Japan wax (esters of dibasic acids having 16 to 22 carbon atoms and glycerol), bees wax (esters of fatty acids having 16 to 32 carbons and alcohols, and hydrocarbons), spermaceti (esters of a fatty acid having 16 carbon atoms and alcohols), montan wax (esters of fatty acids having 20 to 32 carbons and alcohols, and a resinoid), ozokerite (hydrocarbons), ceresin (ozokerite purified to white), polyethylene wax, Fischer-Tropsch wax (hydrocarbons having 17 to 78 carbon atoms), amide wax (fatty acid amides or bisamides), hardened caster oil (caster wax, glycerol 12-hydroxystearate), synthetic wax mainly composed of esters of monohydric alcohols and fatty acids, and Guerbet wax (ester) obtained from branched higher alcohols and fatty acids by the Guerbet reaction. They can be used either alone or as a combination of two or more of them. Preferred commercial waxes include Nopco 1245-M-SN and Nopcoat PEM-17 manufactured by San Nopco Ltd., and WF-640, W-700 and W-200 of the Chemipearl series manufactured by Mitsui Petrochemical Industries, Ltd. The content of wax is preferably from 1% to 10% by weight, and more preferably from 2% to 9% by weight, based on the resin solid content.

Various additives such as an UV absorber, a light stabilizer, an antioxidant, a water resistance-imparting agent, a preservative, a surfactant, a viscosity improver, a fluidity improver, a pH adjusting agent, a leveling agent and an antistatic agent can also be added to the first protective layer Cs1 and the second protective layer Cs2, as needed. These additives may be added to either only one of the above-mentioned two layers or both.

The thickness of the whole thermoplastic resin layer Cs (the first protective layer Cs1 and the second protective layer Cs2) is preferably from 2 to 50 μm, more preferably from 3 to 30 μm, and most preferably from 5 to 30 μm. Less than 2 μm results in the possibility of the sufficient image protective effect failing to be obtained, whereas exceeding 50 μm results in the possibility of transparency being lowered. Further, there is no particular limitation on the thickness of each layer, as long as it is appropriately adjusted so that the thickness of the whole thermoplastic resin layer Cs is within the above-mentioned range, considering the degree of unevenness of the recording surface and image qualities (such as transparency and gloss). However, the thickness of the first protective layer Cs1 is preferably from 1 to 28 μm, and the thickness of the second protective layer Cs2 is from 2 to 29 μn.

In producing the protective film S shown in FIG. 1, first, coating solutions (aqueous resin emulsions) for the first protective layer Cs1 and the second protective layer Cs2 are each prepared. Then, the coating solution for the first protective layer Cs1 is applied onto the support Bs subjected to necessary treatment such as the release treatment, and dried. Thereafter, the second protective layer Cs2 is applied thereto, and dried, thereby being able to produce the protective film S. Application of the coating solution can be carried out by various coating methods such as roll coating, rod bar coating and air knife coating.

The method for producing the recorded matter of the invention using the above-mentioned image protective film will be described below, based on one preferred embodiment using the above-mentioned protective film S.

The method for producing the recorded matter according to this embodiment (hereinafter also briefly referred to as the “production method”) comprises an image formation process of ejecting ink to a recording surface of a recording medium by an ink jet system to form an image, and an overcoat process of heat pressing the above-mentioned protective film S on the recording surface on which the image has been formed, through the thermoplastic resin layer Cs, followed by separation of the above-mentioned support Bs.

The above-mentioned recording medium used in the production method of the invention may be any as long as ink jet recording is possible thereon. Examples the recording media include woodfree paper, recycled paper, copy paper, bond paper, ink jet recording paper, art paper, coated paper, cast-coated paper, resin-coated paper, baryta paper, paper boards, Japanese paper, nonwoven fabric, and a film of a resin such as polyethylene, polypropylene, polystyrene or polyethylene terephthalate. In particular, the above-mentioned ink jet recording paper is best for ink jet recording, and preferred because the printed matter high in image quality and appearance quality, and high in storage ability, which is comparable to a silver salt photograph, can be prepared, coupled with the protective layer according to the invention. The protective film of the invention can generally form the protective layer excellent in adhesion, also to a surface of the ink jet recording paper poor in smoothness of the surface.

The above-mentioned ink jet recording paper comprises a base material having provided thereon an ink-receiving layer containing inorganic particles. The base materials include a plastic film such as a polyethylene film, a polypropylene film, or a polyethylene terephthalate film, and a paper sheet such as woodfree paper, coated paper or laminated paper.

As the above-mentioned inorganic particles, there are preferably used particles of a porous inorganic compound such as porous amorphous silica, porous amorphous alumina or porous amorphous magnesium carbonate. The content of the inorganic particles is preferably from 30% to 90% by weight, based on the solid content in the ink-receiving layer.

The above-mentioned ink-receiving layer contains an aqueous solution or an emulsion of a water-soluble polymer such as polyvinyl alcohol, polyvinyl acetate or an acrylic polymer as a binder for the inorganic particles. The content of the binder is preferably from 5 parts to 60 parts by weight based on 100 parts by weight of the above-mentioned porous inorganic particles. One or more of various additives such as a dye fixing agent, a fluorescent brightening agent, an antifungal agent, a preservative, a surfactant, a viscosity improver, a pH adjusting agent, a defoaming agent, a hardener, a leveling agent and an UV absorber can also be added to the ink receiving layer as needed.

The ink-receiving layer can be formed by applying a coating solution containing the inorganic particles and the binder onto the base material by various methods such as roll coating, rod bar coating and air knife coating. In this case, the thickness of the ink-receiving layer is preferably from 10 to 60 μm, from the viewpoints of ink absorptivity and prevention of powder omission. Further, there is no particular limitation on the feel and texture of the ink-receiving layer, and the ink-receiving layer may have a matte tone, a high gloss tone such as mirror-finished product by a cast method, or a half gloss tone.

The ink used in the production method of the invention may be any, either a dye ink or a pigment ink, as long as it is an ink for ink jet recording. The ink for ink jet recording is generally an ink in which a colorant such as a dye or a pigment is added to water, and usually, various organic solvents and surfactants are further added for moisture retention and permeation adjustment. In particular, the pigment ink is excellent in light resistance and water resistance of a recorded image, compared to the dye ink, so that printed matter excellent in long-term storage ability can be prepared, coupled with the effect of the protective film of the invention. Accordingly, the pigment ink is preferred. When a color image is formed, there are used inks of three primary colors of subtractive color mixing, yellow, magenta and cyan, or inks of four or more colors in which black or other colors are added thereto.

FIG. 2 is a schematic side view showing a substantial part of a production apparatus used for carrying out the above-mentioned production method of the invention. This production apparatus 10 has a structure that a heat transfer mechanism is incorporated in the rear of a recording head of an ink jet printer corresponding to rolled paper, and comprises an ink jet recording unit 1 used in the above-mentioned image formation step, and an overcoat unit 2 used in the above-mentioned overcoat step. Further, a cutter 3 is installed in the vicinity of a paper delivery so that a continuous sheet (long sheet) is cut to a desired length and the resulting cut sheets can be discharged. The structure of each unit of the production apparatus 10 is substantially similar to that of a known ink jet printer and heat transfer mechanism.

The ink jet recording unit 1 has the recording head 11 scanned bi-directionally in a direction perpendicular to a conveying direction of a recording medium M, and each color ink is ejected to a recording surface of the recording medium M rolled up in the roll form, through jet nozzle openings of a nozzle opening face lla based on image information supplied. Conveying of the recording medium M and bi-directional scanning of the recording head 11 are repeated, thereby forming a desired image on the recording surface.

The recording head 11 may be either of a continuous system of continuing to eject the ink at regular time intervals and deflecting the ejected ink droplets, thereby forming an image, or of an on-demand system of ejecting the ink corresponding to image data. However, the on-demand system is preferred, because precise control of ejection is possible and the amount of waste fluid is small. Further, the ink jet systems include a system of ejecting the ink using an electromechanical transducer such as a piezoelectric element, and a system of ejecting the ink by heating the ink using an electrothermal transducer such as a heating resistor-containing heater element. However, there is no particular limitation thereon in the invention.

The overcoat unit 2 comprises a supply means 21 for supplying the protective film S onto the recording surface of the recording medium M, a heat pressing means 22 for heat pressing the thermoplastic resin layer Cs (the first protective layer Cs1 and the second protective layer Cs2) of the protective film on the recording surface on which the image has been formed, and a separating means 23 for separating the support Bs from the heat-pressed thermoplastic resin layer Cs.

The supply means 21 comprises the protective film S, a supply roll on which the protective film S is rolled up and which acts as a rotation center in supplying the film, and an angle-adjusting roll for adjusting the supply angle of the protective film S rolled out to the recording medium M.

The heat pressing means 22 comprises a pair of heater-containing rolls (heat rolls), and the clearance between both rolls can be arbitrarily set and adjusted. Thus, the heat pressing treatment can be applied to the sheet-like material passing between the pair of rolls. The heat pressing means may be any, such as a thermal head, an iron or a commercial laminator, as long as it can apply the heat pressing treatment to the sheet-like material.

The separating means 23 comprises an angle-adjusting roll for adjusting the separation angle of the support Bs and a take-up roll for taking up the support Bs.

In the overcoat unit 2 having the structure described above, the overcoat process proceeds in the following manner. First, the protective film S is supplied onto the recording surface of the recording medium M on which the image has been formed by means of the ink jet recording unit 1, with the supply means 21 so that the recording surface and the second protective layer Cs2 face each other, and laminated thereon to form a laminated product.

Then, the laminated product is allowed to pass through a nip portion between the pair of rolls of the heat pressing means 22, and pressed under heating (heat pressing treatment). The heating temperature at this time is a temperature equal to or higher than the Tg of the thermoplastic resin forming the second protective layer Cs2. This heating temperature is low, compared to the heating temperature applied to the treatment of a conventional monolayer-structure protective film.

The resin of the second protective layer Cs2 in contact with the recording surface is melted by this heat pressing treatment to have fluidity, and fitted in unevenness of the recording surface to exhibit sufficient adhesive force. As a result, the thermoplastic resin layer Cs is pressed to the recording surface with good adhesion to form a protective layer C. On the other hand, heating conditions (heating temperature and heating time) employed in the above-mentioned heat pressing treatment are so mild as not to deteriorate the recorded image, so that there is no fear of disadvantages such as discoloration of the recorded image. Then, when the temperature of the above-mentioned laminated product has been lowered, the support Bs is separated by means of the separating means 23. At this time, the thermoplastic resin layer Cs (protective layer C) is firmly adhered onto the recording surface, so that it does not happen that the thermoplastic resin layer Cs comes up or peels off from the recording surface with the separation of the support Bs. Accordingly, the recorded matter with the protective layer having no image distortion is obtained.

The image protective film of the invention may be any, as long as it is a film comprising a support having laminated thereon a first protective layer and a second protective layer in this order, each of which is formed of a thermoplastic resin, and various changes and modifications are possible in the invention without departing from the spirit and scope thereof.

### EXAMPLES

The present invention will be illustrated in greater detail with reference to the following examples, but the invention should not be construed as being limited thereto.

Production of Protective Films

Each coating solution (aqueous resin emulsion) containing various materials for forming each thermoplastic resin layer was uniformly applied in a specified amount onto the whole surface on one side of some of the supports 1 to 4 with a wire bar to produce protective films 1 to 22. The constitution of the thermoplastic resin layers in the respective protective films is shown in Tables 1 and 2.

Support 1: PET film (PET Lumilar S10 manufactured by PANAC, thickness: 38 μm)

Support 2: OPP Film whose thermoplastic resin layer-forming surface was subjected to corona discharge treatment (OPU-1 manufactured by Tohcello, Co., thickness: 20 μm)

Support 3: PET film whose surface opposite to the thermoplastic resin layer-forming surface was subjected to release treatment (silicone resin coating) (SP-PET-03-50BU manufactured by PANAC, thickness: 50 μm)

Support 4: PET film whose surface opposite to the thermoplastic resin layer-forming surface was subjected to release treatment (melamine resin coating) (PET-383G-1) manufactured by PANAC, thickness: 38 μm)

TABLE 1

| | Thermoplastic Resin Layer | | | | | | | | | |
|---|---|---|---|---|---|---|---|---|---|---|
| | | | | | | Second Protective Layer | | | | |
| | First Protective Layer | | | | | | | Complex | Complex | |
| | | Weight | Film | | | | Weight | Elastic | Elastic | |
| Protective | Thermoplastic | Average | Forming | | Thick- | | Average | Modulus | Modulus | Thick- |
| Film No. | Resin | Tg | Auxiliary | Wax | ness | Thermoplastic Resin | Tg | (40° C.) | (100° C.) | ness |
| 1 | Voncoat 9404 | 40° C. | — | — | 5 μm | Voncoat EC-819 | 11° C. | 2.1 × 10⁷ Pa | 1.9 × 10⁵ Pa | 15 μm |
| 2 | Acrit WEM-030U | 66.2° C. | — | — | 5 μm | Voncoat EC-819 | 11° C. | 2.1 × 10⁷ Pa | 1.9 × 10⁵ Pa | 15 μm |
| | (core shell type) | | | | | | | | | |
| 3 | Acrit WEM-030U | 66.2° C. | 5 wt %*) | — | 5 μm | Voncoat EC-819 | 11° C. | 2.1 × 10⁷ Pa | 1.9 × 10⁵ Pa | 15 μm |
| | (core shell type) | | | | | | | | | |
| 4 | Acrit WEM-030U | 66.2° C. | — | 3 wt %*) | 5 μm | Voncoat EC-819 | 11° C. | 2.1 × 10⁷ Pa | 1.9 × 10⁵ Pa | 15 μm |
| | (core shell type) | | | | | | | | | |
| 5 | Acrit WEM-030U | 66.2° C. | 5 wt %*) | 3 wt %*) | 5 μm | Voncoat EC-819 | 11° C. | 2.1 × 10⁷ Pa | 1.9 × 10⁵ Pa | 15 μm |
| | (core shell type) | | | | | | | | | |
| 6 | Acrit WEM-030U | 66.2° C. | 5 wt %*) | 3 wt %*) | 5 μm | Acrit WEM-202U | 20.8° C. | 5.3 × 10⁷ Pa | 2.3 × 10⁵ Pa | 15 μm |
| | (core shell type) | | | | | (core shell type) | | | | |
| 7 | Acrit WEM-030U | 66.2° C. | 5 wt %*) | 3 wt %*) | 5 μm | Voncoat 9404/EC-819 | 24° C. | 6.1 × 10⁷ Pa | 2.5 × 10⁵ Pa | 15 μm |
| | (core shell type) | | | | | (weight ratio 1/3) | | | | |
| 8 | Voncoat 9404 | 40° C. | 5 wt %*) | 3 wt %*) | 5 μm | Acrit WEM-030U | 66.2° C. | 4.5 × 10⁸ Pa | 8.4 × 10⁵ Pa | 15 μm |
| | | | | | | (core shell type) | | | | |
| 9 | Voncoat 9404 | 40° C. | 5 wt %*) | 3 wt %*) | 5 μm | Acrit WEM-030U/- | 41° C. | 3.2 × 10⁸ Pa | 2.7 × 10⁵ Pa | 15 μm |
| | | | | | | 202U | | | | |
| | | | | | | (weight ratio 1/1) | | | | |
| 10 | Voncoat 9404 | 40° C. | — | — | 20 μm | — | — | — | — | — |
| 11 | Voncoat 9404 | 40° C. | — | — | 5 μm | Acrit 34042MA | 105° C. | 7.5 × 10⁸ Pa | 6.3 × 10⁶ Pa | 15 μm |

*)based on resin solid content

TABLE 2

| | Thermoplastic Resin Layer | | | | | | | | | | |
|---|---|---|---|---|---|---|---|---|---|---|---|
| | First Protective Layer | | | | | | Second Protective Layer | | | | |
| | | Weight | | Film | | | | Weight | In- | Film | |
| Protective | Thermoplastic | Average | Inorganic | Forming | | Thick- | Thermoplastic | Average | organic | Forming | Thick- |
| Film No. | Resin | Tg | Particle | Auxiliary | Wax | ness | Resin | Tg | Particle | Auxiliary | ness |
| 12 | Voncoat EC-819 | 11° C. | P-73 | 5 wt %*) | — | 5 μm | Voncoat EC-819 | 11° C. | — | — | 15 μm |
| | | | 30 wt % | | | | | | | | |
| 13 | Voncoat EC-819 | 11° C. | P-78D | 5 wt %*) | — | 5 μm | Voncoat EC-819 | 11° C. | P-78D | — | 15 μm |
| | | | 30 wt % | | | | | | 5 wt % | | |
| 14 | Voncoat EC-819 | 11° C. | ST-50 | 5 wt %*) | — | 6 μm | Voncoat EC-819 | 11° C. | — | — | 15 μm |
| | | | 5 wt % | | | | | | | | |
| 15 | Voncoat EC-819 | 11° C. | ST-50 | 5 wt %*) | 3 wt %*) | 5 μm | Acrit WEM-202U | 20.8° C. | — | — | 15 μm |
| | | | 30 wt % | | | | (core shell type) | | | | |
| 16 | Voncoat EC-819 | 11° C. | ST-50 | 5 wt %*) | — | 5 μm | Voncoat EC-819 | 11° C. | — | — | 15 μm |
| | | | 70 wt % | | | | | | | | |
| 17 | Acrit WEM-030U | 66.2° C. | ST-50 | 5 wt %*) | 3 wt %*) | 5 μm | Voncoat EC-819 | 11° C. | — | — | 15 μm |
| | (core shell type) | | 10 wt % | | | | | | | | |
| 18 | Movinyl 8030 | 17° C. | — | — | 3 wt %*) | 4 μm | Movinyl 727 | 30° C. | — | 3 wt %*) | 4 μm |
| 19 | Movinyl 8030 | 17° C. | ST-50 | — | 3 wt %*) | 4 μm | Movinyl 727 | 30° C. | — | 3 wt %*) | 4 μm |
| | | | 10 wt % | | | | | | | | |
| 20 | Movinyl 8030 | 17° C. | — | — | 5 wt %*) | 4 μm | Movinyl 870 | 35° C. | — | 3 wt %*) | 4 μm |
| 21 | Movinyl 8030 | 17° C. | — | — | 3 wt %*) | 4 μm | Movinyl 727 | 30° C. | — | 3 wt %*) | 4 μm |
| 22 | Movinyl 8030 | 17° C. | ST-50 | — | 3 wt %*) | 4 μm | Movinyl 727 | 30° C. | — | 3 wt %*) | 4 μm |
| | | | 10 wt % | | | | | | | | |

*)based on resin solid content

The thermoplastic resins shown in the above-mentioned tables are as follows:

Voncoat 9404: Acrylic resin emulsion manufactured by Dainippon Ink & Chemicals, Inc.;

Voncoat EC-819: Acrylic resin emulsion manufactured by Dainippon Ink & Chemicals, Inc.;

Acrit WEM-030U: Acrylic resin emulsion manufactured by Taisei Chemical Industries, Ltd., Tg of core portion: 77° C., Tg of shell portion: 40° C., core portion/shell portion weigh ratio=60/40;

Acrit WEM-202U: Acrylic resin emulsion manufactured by Taisei Chemical Industries, Ltd., Tg of core portion: 8° C., Tg of shell portion: 40° C., core portion/shell portion weigh ratio=60/40;

Acrit 34042MA: Acrylic resin emulsion manufactured by Taisei Chemical Industries, Ltd.;

Movinyl 8030: Colloidal silica complex acrylic resin emulsion manufactured by Clariant Polymer Co., Ltd.;

Movinyl 727: Acrylic resin emulsion manufactured by Clariant Polymer Co., Ltd.; and

Movinyl 870: Acrylic-styrene resin emulsion manufactured by Clariant Polymer Co., Ltd.

Further, the inorganic particles shown in the above-mentioned tables are as follows:

P-73: Gel type silica (trade name: Mizukasil) manufactured by Mizusawa Industrial Chemicals, Ltd., particle size: 2.5 μm;

P-78D: Gel type silica (trade name: Mizukasil) manufactured by Mizusawa Industrial Chemicals, Ltd., particle size: 8.0 μm; and

ST-50: Colloidal silica (trade name: Snowtex) manufactured by Nissan Chemical Industries, Ltd., particle size: 25 nm.

Furthermore, butyl cellosolve (used in the first protective layer) and texanol (used in the second protective layer) were used as the film forming auxiliaries. As the wax, a wax emulsion, Sanleaf CLA-3, manufactured by Sanyo Chemical Industries, Ltd. was used in the protective films 18 to 22, and Chemipearl WF-640 manufactured by Mitsui Chemicals, Inc. was used in the other protective films.

The complex elastic moduli shown in the above-mentioned tables are values determined as complex elastic moduli at 40° C. and 100° C. in a temperature dispersion curve of dynamic viscoelasticity measured with a DMS 6100 viscoelastic spectrometer of the nonresonant forced extension vibration type manufactured by Seiko Instruments, Inc., at a temperature of 21±2° C. and a humidity of 60%±5%, under an atmosphere of nitrogen gas stream, at a frequency of 1 Hz, a rate of temperature increase of 2° C./minute and a minimum tension of 10 mN. In the measurement of dynamic viscoelasticity, an emulsion of a resin to be measured was applied onto a biaxially oriented polypropylene (OPP) resin film, dried at 100° C. for 2 minutes, and allowed to stand overnight to form a coating film of the resin on the OPP resin film. This coating film was used as a sample for measurement.

For the above-mentioned protective films 1 to 22, blocking resistance in film storage (storage ability) was evaluated by the following method. Results thereof are shown in the following Table 3.

<Blocking Resistance in Film Storage (Storage Ability)>

Two A-4 size sheets prepared for each protective film described above were overlapped so that the thermoplastic resin layer of the one sheet faced to the support of the other, and allowed to stand for 24 hours under conditions of 50° C. and 0% RH with a load of 300 g/cm² applied from above. Then, the two overlapped sheets were separated from each other at a separation angle (an angle between the thermoplastic resin layer and the support facing to each other) of 130 degrees and a separation speed of 30 cm/min, and the state of the face which had been overlapped was visually observed and evaluated according to the following criteria:

Evaluation Criteria

A: No transfer of the thermoplastic resin layer to the support is observed at all. Blocking does not occur even in the long-term storage to show good storage ability.

B: The thermoplastic resin layer is partly transferred to the support, but this poses practically no problem.

C: The transfer of the thermoplastic resin layer to the support is somewhat distinctive, and this is a practical limit.

D: The greater part of the thermoplastic resin layer is transferred to the support, and this is of no practical use.

Production of Recorded Matter

Using an ink jet printer (MC2000 manufactured by Seiko Epson Corporation), aqueous pigment inks of 6 colors of yellow, magenta, cyan, light magenta, light cyan and black were each printed on a recording surface of a recording medium (MC photographic paper manufactured by Seiko Epson Corporation) at an ejection amount of 3.5 mg/cm² to produce recorded matter.

Production of Heat-Pressed Products

The above-mentioned protective film was laminated on a print surface of the above-mentioned recorded matter so that the thermoplastic resin layer faced to the print surface, and the resulting laminated product was passed through a pair of heat rolls to conduct heat pressing treatment (line pressure: 5.0 kN/cm², as for the heating temperature, see the following Table 3), thereby producing a heat-pressed product of the above-mentioned recorded matter and any one of the above-mentioned protective films 1 to 22. The respective products thus obtained were used as samples of Examples 1 to 21 and Comparative Examples 1 and 2.

For the samples (heat-pressed products of the recorded matter and the protective films) of Examples 1 to 21 and Comparative Examples 1 and 2, the releasability was evaluated by the following method. Further, for recorded matter with the protective layer obtained by separating each sample described above from the support, the appearance, scratching resistance and blocking resistance were evaluated by the following methods, respectively. Results thereof are shown in the following Table 3.

<Evaluation Method of Releasability>

Only the support was separated from each sample (heat-pressed product of the recorded matter and the protective film at a separation angle between the support and the recorded matter) of 180 degrees and a separation speed of 100 cm/min to obtain the recorded matter with the protective layer. The state in the separation and a surface of the protective layer of the recorded matter with the protective layer were visually observed and evaluated according to the following criteria:

Evaluation Criteria

A: The thermoplastic resin layer does not come up from the print surface of the recorded matter to cause no occurrence of blurring or peeling off of the image. The releasability is good.

B: The coming up of the thermoplastic resin layer from the print surface is partly observed in the separation of the support, and the blurring or peeling off of the image is somewhat observed. However, this poses practically no problem.

C: The coming up of the thermoplastic resin layer from the print surface is observed in considerable parts in the separation of the support, and a part of the image is transferred to the support. The blurring or peeling off of the image is serious. This is not practicable.

<Evaluation Method of Appearance>

The protective layer of the above-mentioned protective film with the protective layer was visually observed. One which had transparency and in which the inclusion of bubbles and the occurrence of cracks were not observed was evaluated as A (good appearance), one which was somewhat poor in transparency, or in which the inclusion of bubbles was somewhat observed or there were very minute cracks was evaluated as B (practically no problem), and one which was extremely poor in transparency, or in which the inclusion of bubbles was clearly observed or cracks were distinctive was evaluated as C (not practicable).

<Evaluation Method of Scratch Resistance>

A surface of the protective layer of the above-mentioned protective film with the protective layer was lightly rubbed with a back side of the above-mentioned MC photographic paper, and then visually observed. One in which the surface did not get scratched was evaluated as A (good scratch resistance), and one in which the surface got scratched was evaluated as B (practically no problem).

<Evaluation Method of Blocking Resistance>

Two A-4 size sheets of the above-mentioned recorded matter with the protective layer were overlapped so that a surface of one sheet (a surface of the protective layer) faced to a back side of the other (a back side of the MC photographic paper), and allowed to stand for 24 hours under conditions of 50° C. and 60% RH with a load of 300 g/cm² applied from above. Then, the two overlapped sheets were separated from each other at a separation angle (an angle between the protective layer and the recording medium facing to each other) of 130 degrees and a separation speed of 30 cm/min, and the state of an overlapped face was visually observed and evaluated according to the following criteria:

A: No transfer of the protective layer to the back side is observed at all. Blocking resistance is good.

B: The protective layer is partly transferred to the support, but this poses practically no problem.

C: The greater part of the protective layer is transferred to the back side, and this is of no practical use.

TABLE 3

| | | | | Heating Tempera- | | Printed Matter with Protective Layer | | |
|---|---|---|---|---|---|---|---|---|
| | Support | Protective film | Storage | ture in Pressing | | | Scratch | Blocking |
| | No. | No. | ability | (° C.) | Releasability | Appearance | Resistance | Resistance |
| Example 1 | 1 | 1 | C | 40 | A | A | B | B |
| Example 2 | 1 | 2 | C | 40 | A | B | B | A |
| Example 3 | 1 | 3 | C | 40 | A | A | B | A |
| Example 4 | 1 | 4 | C | 40 | A | B | A | A |
| Example 5 | 1 | 5 | C | 40 | A | A | A | A |
| Example 6 | 1 | 6 | B | 40 | A | A | A | A |
| Example 7 | 1 | 7 | B | 40 | A | A | A | A |
| Example 8 | 1 | 8 | A | 40 | A | B | A | A |
| Example 9 | 1 | 9 | B | 40 | A | A | A | A |
| Example 10 | 1 | 11 | A | 110 | B | B | B | B |
| Example 11 | 1 | 12 | C | 40 | A | B | A | A |
| Example 12 | 1 | 13 | B | 40 | A | B | A | A |
| Example 13 | 1 | 14 | C | 40 | A | A | B | B |
| Example 14 | 1 | 15 | B | 40 | A | A | A | A |
| Example 15 | 1 | 16 | C | 40 | A | B | B | A |
| Example 16 | 1 | 17 | C | 40 | A | A | A | A |
| Example 17 | 2 | 18 | A | 100 | A | A | A | A |
| Example 18 | 2 | 19 | A | 95 | A | A | A | A |
| Example 19 | 2 | 20 | A | 90 | A | A | A | A |
| Example 20 | 3 | 21 | A | 100 | A | A | A | A |
| Example 21 | 4 | 22 | A | 100 | A | A | A | A |
| Comparative | 1 | 10 | B | 50 | C | C | B | B |
| Example 1 | | | | | | | | |
| Comparative | 1 | 1 | C | Not heated | C | C | B | C |
| Example 2 | | | | | | | | |

Further, heat-pressed products and recorded matter with the protective layer were produced in the same manner as described above with the exception that a recording medium (PM photographic paper manufactured by Seiko Epson Corporation) smoother than the MC photographic paper was used as the recording medium. For these, the releasability, appearance, scratch resistance and blocking resistance were evaluated. As a result, the same results as described above were obtained.

In the image protective film of the invention, the protective layer (thermoplastic resin layer) comprises two layers of a layer acting as a surface protective layer for an image face (the first protective layer) and a layer acting as an adhesive layer for the image face (the second protective layer), and excellent characteristics corresponding to the role of each layer are imparted thereto. Accordingly, the heat transfer treatment can be smoothly carried out, and good protective characteristics can be given to the image face. That is to say, according to the image protective film of the invention, in heat pressing with the support, the adhesion between the protective layer (thermoplastic resin layer) and the recording surface can be provided even to the recording surface low in smoothness under such relatively mild heating conditions that the recorded image is not deteriorated. In separating the support, the support can be separated smoothly and cleanly without coming up of the thermoplastic resin layer from the recording surface. As a result, there can be provided high quality recorded matter with the protective layer, in which the image is not distorted, the inclusion of bubbles is not observed between the protective layer and the recording surface, which is high in color development and also excellent in scratch resistance and blocking resistance. Further, the image protective film of the invention is hard to bring about the blocking of the film even when it is stored for a long period of time. Thus, the film is excellent in storage ability.

While the present invention has been described in detail and with reference to specific embodiments thereof, it will be apparent to one skilled in the art that various changes and modifications can be made therein without departing from the spirit and scope thereof.

The present invention is based on Japanese Patent Application Nos. 20002-079766 (filed Mar. 20, 2002), 2002-243485 (filed Aug. 23, 2002) and 2002-370058 (fled Dec. 20, 2002), the contents thereof being incorporated herein by reference.

What is claimed is:

1. An image protective film used for lamination on a recoding surface of a recording medium by a heat transfer type overcoat system after the formation of an image on the recording surface, which comprises a support having laminated thereon a first protective layer and a second protective layer in this order, each of which is formed of a thermoplastic resin.

2. The image protective film according to claim 1, wherein the thermoplastic resin forming the first protective layer has a higher glass transition temperature than the thermoplastic resin forming the second protective layer.

3. The image protective film according to claim 2, wherein the difference in glass transition temperature between the thermoplastic resin forming the first protective layer and the thermoplastic resin forming the second protective layer is from 10° C. to 100° C.

4. The image protective film according to claim 2 or 3, wherein the glass transition temperature of the thermoplastic resin forming the first protective layer is from 30° C. to 130° C.

5. The image protective film according to claim 1, wherein the first protective layer contains inorganic particles.

6. The image protective film according to claim 5, wherein the content of the inorganic particles is from 10% to 60% by weight based on the resin solid content.

7. The image protective film according to claim 5 or 6, wherein the inorganic particles are colloidal silica.

8. The image protective film according to any one of claims 1 to 7, wherein the complex elastic modulus of the thermoplastic resin forming the second protective layer at 40° C. in a temperature dispersion curve of dynamic viscoelasticity measured at a frequency of 1 Hz, a rate of temperature increase of 2° C./minute and a minimum tension of 10 mN is 4.0×10⁸ Pa or more.

9. The image protective film according to any one of claims 1 to 8, wherein the complex elastic modulus of the thermoplastic resin forming the second protective layer at 100° C. in a temperature dispersion curve of dynamic viscoelasticity measured at a frequency of 1 Hz, a rate of temperature increase of 2° C./minute and a minimum tension of 10 mN is 2.5×10⁵ Pa or less.

10. The image protective film according to any one of claims 2 to 9, wherein the glass transition temperature of the thermoplastic resin forming the second protective layer is from −20° C. to 60° C.

11. The image protective film according to any one of claims 1 to 10, wherein the first protective layer contains wax.

12. A method for producing recorded matter using an image protective film according to any one of claims 1 to 11, which comprises the steps of forming an image on a recording surface of a recording medium, and laminating the image protective film on the image-recorded recording medium so that the recording surface and the second protective layer overlap, followed by heat pressing, wherein the heating temperature in the heat pressing is equal to or higher than the glass transition temperature of the thermoplastic resin forming the second protective layer.

13. The method according to claim 12, wherein the image is formed by an ink jet system.

14. Recorded matter produced by a method according to claim 12 or 13.
